(19) United States
(12) Patent Application Publication
(10) Pub. No.: US 2003/0093297 A1
(43) Pub. Date: May 15, 2003

(54) Method for providing feedback as to product efficacy

(76) Inventors: Kurt Matthew Schilling, Totowa, NJ (US); Ian Richard Scott, Allendale, NJ (US); Miles Hugh Eddowes, Edgewater, NJ (US); Susanne Teklits Iobst, Maywood, NJ (US)

Correspondence Address: UNILEVER, PATENT DEPARTMENT, 45 RIVER ROAD, EDGEWATER, NJ, 07020, US

(21) Appl. No.: 10/255,007

(22) Filed: Sep. 25, 2002

Related U.S. Application Data
(60) Provisional application No. 60/337,900, filed on Nov. 8, 2001.

(51) Int. Cl. G06F 17/60

(52) U.S. Cl. 705/2

(57) ABSTRACT

A method of providing a system of providing feedback to a consumer regarding the efficacy of a treatment product prior to the time at which the efficacy is perceivable by ordinary means to a consumer.

This application claims priority under 35 U.S.C. 119 from U.S. provisional application Serial No. 60/337,900 filed Nov. 8, 2001.

### FIELD OF THE INVENTION

The present invention relates to a method of providing consumers feedback as to the efficacy of a product in a time frame that is substantially shorter than the time recommended for using the product. More specifically, the present invention relates to a business method of growing sales through consumer compliance with the use of a product for a recommended regimen by the use of diagnostic tools demonstrating improvement before it is ordinarily perceivable to the consumer.

### BACKGROUND OF THE INVENTION

When consumers use products or regimens, they expect a benefit. In many cases that benefit is immediately apparent and consumers get immediate feedback that the product or regimen is, or is not, working as expected. In many cases however, benefits are only apparent over longer time periods—such as use of anti-wrinkle products for aging skin where several weeks or months of use are necessary to achieve full benefit. In extreme cases, the benefit may never be apparent to the consumer. An example would be technology that acts prophylactically, such as antioxidant technology to slow the aging process, where the benefit is that the skin changes less with age than it would have without the treatment.

In such cases the consumer has no way to know if the product or regimen is working or not and may give up on the product or regimen before it has had a chance to deliver its benefit. Thus there is a need to provide a system, process or device that gives the consumer early and ongoing indications that the product or regimen is, or is not, working.

Systems for recommending products based on consumer attributes have been described. For example, WO 01/58238, an international patent application assigned to Collaborative Technologies, relates to a make-up counseling apparatus suitable for counselors to provide counseling on make-up of a subject. Shiseido's European Patent Application EP 1 202 209, equivalent to WO 01/82154, relates to a method and system for producing customized cosmetic and pharmaceutical formulations on demand based on retrieving a user profile associated with the user.

Procter & Gamble's Visia Complexion Analysis System is a photographic imaging tool that provides clinical measurement and analysis of topical and subsurface facial skin conditions. The system allows medical and skin care professionals to better track treatments outcomes.

However, a process for providing consumers feedback on the efficacy of a product or regimen prior to the effects becoming perceivable to the consumer by ordinary means has not been disclosed in the art. Furthermore, a process for motivating and effecting consumer compliance with use of a product for it recommended regimen has not been disclosed in the art.

Therefore, the present invention is based on the concept of providing feedback to consumers as the efficacy of products or regiments prior to the time at which the consumer is able to perceive the benefits by ordinary means.

### SUMMARY OF THE INVENTION

The invention is based on the discovery that there are measurable changes in the condition of consumers using personal care products or regimens, such as skin care products, that precede any readily perceivable benefits, but are predictive of those benefits. Further, it has been discovered that when consumers are provided with this early feedback they, on average, attain greater benefits from using the product than do consumers not provided with this feedback. This provides the basis for a new system or method of selling personal care products or regimens, such as skin care products, where the use of the product or regimen is combined with ongoing feedback on the efficacy of the product or regimen on the individual consumer. The consumer benefits from this combination by achieving greater improvement in his or her condition.

The invention relates to a system of providing feedback as to the efficacy of a treatment product or regimen for a condition of a consumer, such as a skin condition, prior to the time at which the consumer is able to sense the efficacy. Thereby, consumer compliance and benefit from the use of a product is effected, while enhancing sales and profits to the developers, makers or marketers of the products.

### DETAILED DESCRIPTION OF THE INVENTION

As used herein, the following terms are intended to have the stated definitions.

The term “skin” as used herein includes the skin on the face, mouth, neck, chest, back, arms, hands, legs, and scalp. The term “skin” includes all layers of the human skin, including any reference to epidermis or keratinocytes.

As used herein, the term “personal care” includes cosmetic and hygienic personal care of everyday health and appearance, including but not limited to nutrition, age related conditions, skin, hair, or mouth.

The term “diagnostic” as it relates to tests or data, refers to objective measures and/or data characterizing the condition of a personal care category.

As used herein, the term “comprising” includes made up of, composed of, including, consisting and/or consisting essentially of. Except in the operating and comparative examples, or where otherwise explicitly indicated, all numbers in this description indicating amounts or ratios of material or conditions of reaction, physical properties of materials and/or use are to be understood as modified by the word “about”.

The present invention relates to a method for providing consumers with feedback on treatment product or regimen efficacy prior to the time at which the consumer is able to perceive the efficacy.

Part of the method is a knowledge base that is constantly updated with data from new skin samples and with data from ongoing product selections and feedback. This knowledge base, which can be in the form of a database, may be in communication with a recommendation engine or a feedback engine. This communicable connection may be through a computer network. For example, input from consumers and feedback to consumers may be provided via the Internet. Specifically, data measured with diagnostic instruments may be communicated to the database or the data processing portions of the invention via the Internet.

The invention is based on the discovery that there are measurable changes in the condition of consumers using personal care products or regimens, such as skin care products that precede any readily perceivable benefits, but are predictive of those benefits. Further, it has been discovered that when consumers are provided with this early feedback they, on average, attain greater benefits from using the product than do consumers not provided with this feedback. This provides the basis for a new system or method of selling personal care products, such as skin care products, where the use of the product or regimen is combined with ongoing feedback on the efficacy of the product or regimen on the individual consumer. The consumer benefits from this combination by achieving greater improvement in his or her condition.

The invention relates to a system of providing feedback as to the efficacy of a treatment product or regimen for a personal care condition of a consumer, such as a skin condition, prior to the time at which the consumer is able to sense the efficacy.

In another aspect, the invention relates, additionally, to providing the consumer with advice on how to change the product or regimen to maximize his or her benefit. The advice may be provided via interrogation of a computer database correlating changes in the diagnostic measure or measures over time of treatment, with the effect of different products or regimens on people who had similar pattern of diagnosed changes.

In another aspect, a method of providing a system of providing feedback as to efficacy of a treatment product for a skin condition of a consumer includes collecting information from the consumer regarding a plurality of characteristics associated with the skin condition; inputting the information into a computerized knowledge system that selects a product that will be effective for the consumer from at least two products that are effective against said skin condition; and to providing the consumer with the treatment product for treating the skin condition; where the computerized knowledge system is derived from a correlation between responses of a population of individuals to a plurality of products and measured characteristics of each of the individuals prior to use of the plurality of products.

A plurality of diagnostic tools is suitable for the methods and systems of the present invention, as long as the users can perform and interpret the result communicated by the tool without the need to consult a professional. For example, diagnostic tools for measuring the condition of human skin are suitable for use with the methods and systems of the present invention, measuring the following skin conditions.

Measurable Changes in Skin Preceding Visible Benefits

a) Wrinkle reduction. There are many technologies available which claim to reduce wrinkles. Among the best of these are hydroxyacids and retinoids. Benefits beyond those attributable to simple moisturisation take several weeks to appear. Applicants have shown that early measurements of skin properties predict ultimate clinical benefit. Appropriate measures include, but are not restricted to

autofluorescence of the skin to UVA and UVB light

ballistometric measures of skin elastic properties

b) Resistance of skin to stress. Resistance of skin to stress is a function of the strength and integrity of the stratum corneum—neither of which are apparent until the skin is environmentally challenged. Improvements in the strength and integrity of the stratum corneum which are otherwise imperceptible to the consumer include, but are not limited to,

change in Skin Surface Water Loss, a technique that measures the speed with which water enters and is lost from the skin

changes in skin electrical properties

changes in the chemical composition of the stratum corneum

c) Rate of oxidative damage to the skin. Rate of oxidative damage to the skin is a key determinant of how rapidly skin will deteriorate with age. While changes in the rate of oxidative damage are imperceptible, they can be measured in several ways including but not limited to

rate of photon emission after UV light exposure

level of oxidized lipids or proteins on the skin surface

Similar measures predicting product benefits can be found for a wide variety of skin conditions—acne, rosacea, etc.

The following detailed description is by way of example, not by way of limitation, of the principles of the invention to illustrate the best mode of carrying out the invention.

### EXAMPLE 1

Effect of Feedback on Benefit Achieved by Consumers

Groups of consumers selected at random are provided with identical products or regimens and asked to use them for a defined period of time. The groups are provided with identical information at the outset telling them how to use the product, how long they should expect to use it before seeing benefits and the type of benefit they should expect. The two groups are treated identically except that the test group have their skin evaluated at regular intervals through the treatment period and were given feedback on how well the product was working. At the end of the treatment period both groups are evaluated by self perception and by expert clinical evaluation.

The results show that the group that is provided with regular feedback gains greater benefits than the control group.

### EXAMPLE 2

This example demonstrates that consumer need exists for self-diagnostics of conditions relating to lifestyle, including cosmetic conditions, that do not require supervision of a health professional and where consumers can administer treatment or lifestyle changes themselves.

Four focus group studies were conducted with male and female consumers in North America and Europe. The objectives were to explore consumers' level of activity with home diagnostics tests, and to better understand the barriers and motivations to using these devices. Subjects were asked about the devices they use or are aware of, what they would be interested in monitoring, their confidence in self-diagnostic devices, their likes and dislikes with diagnostic devices and their trust in the results from self-diagnosis.

Most subjects indicated they would not use self-diagnostic devices for measuring parameters related to medical conditions (e.g. heart rate, blood pressure, cholesterol, osteoporosis) as they would need to go to their medical professional any way. Others cited barriers related to perceived accuracy and reliability and the need for interpretation and subsequent treatment by health professionals. Many also saw relevance, ease of use and fit with lifestyle as barriers.

For many, willingness to perform self-diagnostic measures required the ability to also self-treat the condition being monitored. Others were motivated by self-diagnostics combined with personalized advice. Many wanted accurate, reliable results that were easy to interpret. Overall, the results suggested that consumers were motivated by self-diagnosis of conditions which do not require supervision or treatment by a health professional, and which come with advice and self remedies.

This result was unexpected because one skilled in the art would expect that consumers are interested in self-diagnosis of conditions, and that this is so regardless of whether the condition would require consulting a health professional.

### EXAMPLE 3

This example demonstrates that consumer need exists for self-diagnostics as part of a system including advice and solutions to improve and monitor everyday personal care conditions, such as health and appearance.

In addition to those of Example 2, two further focus group studies were conducted with women in North America and Europe, to investigate the appeal and relevance of a web-site designed for women that provides information and personalized solutions for well being in combination with self-diagnostics. Again, consumers showed a reluctance to carry out self-diagnostics if they only produced warnings in the form of negative results related to health and well being, which was unexpected as discussed with reference to Example 2. They questioned the benefits of doing self-diagnostics to identify problems without obtaining related solutions. Furthermore, many subjects needed compelling reasons to conduct frequent diagnostic self-tests (i.e. daily, weekly.)

Most of the focus group participants agreed that self-diagnostics made the most sense when part of a total concept including information and advice, solutions and testing. In the context of confirming the benefit of new personal care or nutritional regimes and treatments, many found diagnostic tests very useful and motivating.

Based on the postive feedback from the focus groups described above, an Internet site concept was created, in which self diagnostics were offered as a means to confirm benefits that consumers get by using recommended products, habits and behaviors for personal care and nutrition meant to improve everyday health and appearance.

The web-site concept had four major components for utilization by the consumer:

i. A mechanism for consumers to choose which aspect of everyday health or appearance they wanted to improve;

ii. A mechanism to set goals for themselves in their chosen area of improvement;

iii. A source for recommended solutions to achieve their goals, including consumer products, treatments, regimes and customized information as well as mechanisms to procure these solutions; and

iv. Self-diagnostic devices to measure their progress against their goals.

To test the attractiveness of this concept, “mocked up” Internet pages representing this information and diagnostics system were presented to women as a way to offer solutions to improve bone health and prevent osteoporosis. The feedback from these focus groups confirmed that self-diagnostics performed to confirm the benefits of self-treatment were much more motivating then self-diagnostics only used to identify bone health problems.

Additionally, this example demonstrates that consumers are receptive to processes for improving a condition including the use of the Internet and self-diagnostics, which may be used at inside or outside the home, to confirm benefits derived from use of products and to motivate the compliance with continued use of such products in accordance with a complete recommended use regimen.

### EXAMPLE 4

This example illustrates how results of a consumer applying an alpha-hydroxy acid/retinoid composition, while not evident to the consumer, may be shown using autofluorescence data.

Six panelists applied a prototype anti-aging topical skin care cream product (retinol & Glycolic acid) to one of their arms twice daily for 12 weeks (84 days). The product composition is set forth in the Table below. Non-invasive auto-fluorescence measurements were taken before and after 21 days (Example A) and 28 days (Example B) of using the product. The benefit achieved was also judged by an expert grader on the Crepey grade (Weinkauf, R. L., et al., “Method for Assessing the Efficacy of Cosmetic Formulations Containing Alpha Hydroxy Acids on Photoaged Skin of the Forearms,” Poster Presentation at American Academy of Dermatology (AAD) Meeting, incorporated by reference herein).

TABLE 1

| CHEMICAL/ | | COMP. 1 |
|---|---|---|
| CTFA NAME | TRADE NAME | (WT. %) |
| WATER, DI | | 44.0 |
| DISODIUM EDTA | SEQUESTERENE Na2 | 0.05 |
| MAGNESIUM ALUMINUM | VEEGUM ULTRA | 0.6 |
| SILICATE | | |
| METHYL PARABEN | METHYL PARABEN | 0.15 |
| SIMETHICONE | ANTIFOAM EMULSION | 0.01 |
| BUTYLENE GLYCOL-1,3 | BUTYLENE GLYCOL-1,3 | 3.0 |
| HYDROXYMETHYL- | NATROSOL 250 HHR | 0.5 |
| CELLULOSE | | |
| GLYCERIN USP | GLYCERIN USP | 2.0 |
| XANTHAN GUM | KELTROL M | 0.2 |
| TRIETHANOLAMINE 99% | TEA 99% | 1.2 |
| STEARIC ACID¹ | PRISTERENE 4911 | 3.0 |
| GLYCERYL | NATURECHEM GMHS | 1.5 |
| HYDROXYSTEARATE¹ | | |
| STEARYL ALCOHOL¹ | LANETTE 18DEO | 1.5 |
| CHOLESTEROL NF¹ | CHOLESTROL NE | 0.5 |
| SORBITAN STEARATE | SORBITAN STEARATE | 1.0 |
| PEG-100 STEARATE | MYRJ 59 | |
| ISOSTEARYL PALMITATE² | PROTACHEM ISP | 6.0 |
| C12-C15 ALCOHOLS | HESTESTER FAO | 3.0 |
| OCTANOATE² | | |
| DIMETHICONE² | SILICONE FLD 200 | 1.0 |
| | (50 CTS) | |
| TOCOPHERYL ACETATE | VITAMIN E ACETATE | 0.10 |
| BUTYLATED | BHT | 0.05 |
| HYDROXYTOLUENE | | |
| PROPYLPARABEN NF | PROPYLPARABEN | 0.1 |
| WATER, DI | | 3.0 |
| L-LACTIC | | — |
| ACID (88%) | | |
| GLYCOLIC ACID 70% | GLYPURE 70 | 11.4 |
| AMMONIUM | AMMONIUM | 2.5 |
| HYDROXIDE 29% | HYDROXIDE 29% | |
| WATER, DI | | 99.51 |
| WATER, DI | | 44.0 |
| RETINOL (51.3%)³ | RETINOL BLEND | 0.29 |
| | (51.3%) | |
| ALPHA-BISABOLOL | ALPHA-BISABOLOL | 0.2 |

¹Barrier ingredients: glyceryl hydroxystearate is a crystalsizing compound, the rest are crystal forming.
²FIuid oil
³A blend containing retinol 51.3%, BHA 0.6%, BHT 3.1% and Tween 2045%.

The autofluorescence data was acquired by synchronous scanning using a Perkin-Elmer (Norwalk, Conn.) LS-50B fluorescence spectrometer. The excitation and emission monochromators are set at an operator-determined wavelength offset and each scanned at the same rate. This technique is commonly used to isolate and detect fluorescence of overlapping bands arising from multiple fluorophores in a mixture. The values given are the intensity values and the ratios of the tryptophan (Trp) band of proteins and Advanced Glycation End-products (AGE). The latter, which are collagen protein cross-links, are a marker of ageing and develop over the course of a lifetime. They occur near 340 nm. The position of Trp fluorescence is near 280 nm. Changes in Trp intensities are used as a marker for cell proliferation in the epidermis. The 340 nm AGE band is used to normalize intensities of the 280 nm Trp band because AGE does not change over the limited time of the study. The intensities were measured at the maxima of each band. Each value is the average of a set of three sites. The sets are distinguished by having either received treatment or no treatment. Each value is the average of three sites. The uncertainties are standard deviations.

The crepey values given are the changes from baseline score. A difference greater than 1.0 is perceivable.

### Example A

The data are that for a subject exhibiting no change in expert-assessed crepey score after eight weeks. Day 1 refers to the first day of the study, before any product application. The change in the fluorescence data occurred after three weeks, indicating that the method has the potential to detect product efficacy before the subject can. As such, it can be used as part of a system to provide feedback to consumers. The subject eventually showed minimal response. Note that crepey data were collected at days 14 and 28. These days, being before and after the auto-fluorescence data was collected at day 21, indicate that there was still no perceivable change in crepey grade at the time fluorescence showed a response.

TABLE 2

| | | | | Crepey |
|---|---|---|---|---|
| | Trp | AGE | Trp/AGE | Score |
| Day 1 | 34.12 ± 4.59 | 9.93 ± 1.99 | 3.51 ± 0.79 | 0.0 |
| Untreated | | | | |
| Day 21 | 28.43 ± 2.93 | 5.15 ± 1.26 | 5.81 ± 1.82 | 0.5 |
| Untreated | | | | (day 14) |
| | | | | 0.0 |
| | | | | (day 28) |
| Day 1 | 29.87 ± 2.33 | 8.62 ± 1.06 | 3.52 ± 0.74 | 0.0 |
| Treated | | | | |
| Day 21 | 88.27 ± 23.51 | 2.75 ± 0.53 | 33.97 ± 16.02 | 1.0 |
| Treated | | | | |

### EXAMPLE B

The data are that for a subject with slow response; i.e., slow, gradual change in crepey score after twelve weeks. There was no change in crepey score after four weeks. In contrast, there was a response in autofluorescence after four weeks.

TABLE 3

| | | | | Crepey |
|---|---|---|---|---|
| | Trp | AGE | Trp/AGE | Score |
| Day 1 | 45.66 ± 1706 | 14.25 ± 1.00 | 3.33 ± 1.24 | 0.0 |
| Untreated | | | | |
| Day 28 | 35.01 ± 10.66 | 14.26 ± 3.30 | 2.56 ± 1.11 | 0.0 |
| Untreated | | | | |
| Day 1 | 48.02 ± 5.61 | 17.16 ± 7.28 | 3.17 ± 1.36 | 0.0 |
| Treated | | | | |
| Day 28 | 62.62 ± 13.89 | 13.54 ± 4.31 | 5.09 ± 2.21 | 0.0 |
| Treated | | | | 0.5 |
| | | | | (day 56) |
| | | | | 2.0 |
| | | | | (day 84) |

The data show that response to treatment may be detected using the diagnostic technique of autofluorescence before response is evident by observation. Providing this information to consumers is part of the business method of the present invention, thereby encouraging their compliance with the product usage regimen.

While the present invention has been described herein with some specificity, and with reference to certain preferred embodiments thereof, those of ordinary skill in the art will recognize numerous variations, modifications and substitutions of that which has been described which can be made, and which are within the scope and spirit of the invention. It is intended that all of these modifications and variations be within the scope of the present invention as described and claimed herein, and that the inventions be limited only by the scope of the claims which follow, and that such claims be interpreted as broadly as is reasonable. Throughout this application, various publications have been cited. The entireties of each of these publications are hereby incorporated by reference herein.

What is claimed is:

1. A method of providing personal care products or regimens to consumers for at least one desired benefit toward a personal care condition, said method comprising giving said consumers feedback during product use and informing said consumers of their personal progress towards the desired benefit; wherein the feedback is based on the results of a diagnostic test that detects early, imperceptible changes in said condition prior to full product benefits being perceivable by the consumer.

2. The method of claim 1, wherein said personal care products are skin care products.

3. The method of claim 2, wherein the consumer benefit being sought is prophylactic in nature and the diagnostic test measures the efficacy of the prophylactic treatment.

4. The method of claim 2, wherein the output of the diagnostic measure is transformed into a communication device intuitively meaningful to the consumer.

5. The method of claim 2 where the communication of the diagnostic test to the consumer is via methods selected from the group consisting of an interactive computer based system, internet, mail, facsimile, point of sale communication, or personal communication.

6. The method of claim 1, wherein the consumer benefit is improving appearance of ageing skin.

7. The method of claim 5, wherein the diagnostic test is based on tests selected from the group consisting of early changes in the autoflouresence properties of the skin, changes in the mechanical properties of the skin, changes in the electrical properties of the skin, changes in the light remission properties of the skin, and changes in the topography of the skin.

8. The method of claim 2, wherein the consumer benefit is increasing the resistance of skin to the drying and damaging effects of environmental stress.

9. The method of claim 1, wherein the diagnostic test is based on tests selected from the group consisting of changes in the chemical composition of the superficial stratum corneum, changes in the electrical conductance properties of the skin, changes in rate of water penetration and release from the stratum corneum, and changes in the remission of light from the skin.

10. The method of claims 2, wherein the consumer benefit being sought is slowing of the aging process in the skin.

11. The method of claim 1, wherein the diagnostic test is based on tests selected from the group consisting of changes in the rate of photon emission from skin after exposure to light, changes in the level of oxidised proteins or lipids in the skin, and changes in the level of antioxidants in the skin.

12. The method of claim 1, wherein the consumer is further provided with advice on how to change the product or regimen to maximize his or her benefit.

13. The method of claim 1, wherein the advice is provided via interrogation of a computer database correlating changes in the diagnostic measure or measures over time of treatment, with the effect of different products or regimens on people who had similar pattern of diagnosed changes.

14. A method of providing a system of providing feedback as to efficacy of a treatment product for a skin condition of a consumer, the method comprising:
(A) collecting information from said consumer regarding a plurality of characteristics associated with said skin condition;
(B) inputting the information into a computerized knowledge system that selects a product that will be effective for said consumer from at least two products that are effective against said skin condition; and
(C) providing the consumer with the treatment product for treating the skin condition;
wherein the computerized knowledge system is derived from a correlation between responses of a population of individuals to a plurality of products and measured characteristics of each of the individuals prior to use of the plurality of products.

15. A method of generating, maintaining and/or growing treatment product sales for a condition of a consumer comprising:
(a) collecting information from said consumer regarding a plurality of characteristics associated with said skin condition;
(b) inputting the information into a computerized knowledge system that selects a product that will be effective for said consumer from at least two products that are effective against said skin condition; and
(c) providing the consumer with the recommended product for treating the skin condition in exchange for payment for the product and/or the recommendation;
(d) providing the consumer with feedback based on diagnostics as to the efficacy of the product prior to subjective evidence of efficacy; wherein said feedback effects consumer compliance with a recommended product regimen; and wherein the compliance at least maintains product sales.
